(19) United States
(12) Patent Application Publication
(10) Pub. No.: US 2006/0025505 A1
(43) Pub. Date: Feb. 2, 2006

(54) Polish having improved abrasion resistance

(76) Inventor: William E. Hammond, Beaverton, OR (US)

Correspondence Address: KOLISCH HARTWELL, P.C., 200 PACIFIC BUILDING, 520 SW YAMHILL STREET, PORTLAND, OR, 97204, US

(21) Appl. No.: 10/911,793

(22) Filed: Aug. 2, 2004

(51) Int. Cl. B24D 3/02; C09G 1/02; C08K 5/24; C08K 3/34

(52) U.S. Cl. 524/261; 51/307; 51/308; 51/309; 106/3; 524/442

(57) ABSTRACT

Durable polishes having improved abrasion resistance that contain silicone and alumina, bentonite clay or silica nanoparticle components for protection of painted metal and plastic surfaces.

### TECHNICAL FIELD

The invention relates to durable polishes having improved abrasion resistance. In particular, the invention relates to durable polishes containing silicone and alumina, bentonite clay or silica nanoparticle components for protection of painted metal and plastic surfaces.

### BACKGROUND

The invention improves upon current technology for the protection of painted metal and plastic surfaces from the effects of environmental exposure. Automotive finishes, boats, aircraft and other surfaces are exposed to ultraviolet radiation, acid rain, wind erosion due to entrained dust and sand, corrosion, and other harsh elements. The value of the vehicle is reduced when the surface finish is pitted or low in gloss. The present invention adds new protection to the polishes that are currently available for these applications while still allowing ease of application and surface preparation.

There is a wide range of products available for the protection of painted surfaces. Some focus on ease of application, but this usually leads to a loss of long-term protection. Products intended for long-term protection are often difficult to apply, requiring special equipment or extensive surface preparation. Additionally, many products on the market have been formulated at less-than-optimal composition to avoid infringement of existing patents. This leads to suboptimal performance by the product.

The present invention combines components used in many conventional polish systems with new materials in novel compositions that enhance the protection and gloss of treated surfaces, while still allowing ease of use. Further, the compositions disclosed herein impart improved abrasion resistance to the treated surface without compromising either the ease of application or the long-term performance of the polish.

### SUMMARY

This invention relates to a novel protective finish that increases the useful life of the surfaces to which it is applied. The finish combines reactive aminosilicone resins and fluids with anhydrous aluminum silicates and bentonite clay. When nanoparticles of silicon, clay or alumina are used in the finish, they are better able to penetrate into microcracks and micropores in the painted surface. This penetration reinforces the surface of the paint, seals it against penetration by oxidizing elements and reduces its tendency to scratch or abrade. These components also increase the impact toughness of the finish, reducing the effects of particulate impact on the coating.

The use of perfluoroalkyl oligomers can enhance the oil resistance and improve the gloss of the surface as well. When combined with the nanoparticle fillers, which scatter light less than previous particles, the transparency of the coating is improved and the color of the paint is enhanced. Further, the impact resistance and resistance to chipping is improved.

### DETAILED DESCRIPTION

A detailed description of one of the preferred embodiments of this patent follows. This description does not limit the compositional variation claimed, nor does it limit future compositional variations.

In one embodiment, the polish is a colloidal suspension having the following composition:

| | Weight Percent |
|---|---|
| Component | Range |
| Water | 60-70 |
| Anhydrous aluminum silicate (KAOPOLITE ™) | 3-10 |
| WITCAMIDE ™ 511 or similar emulsifier | 0.5-1.5 |
| Mineral spirits | 18-25 |
| Aminofunctional silicone fluids | 4-7 |
| (e.g. Dow Corning 531 Fluid, Dow Corning 536 | |
| Fluid or Dow Corning 200 fluid) | |
| Reactive silicone resin (Dow Corning Z-6018) | 0.5-1.5 |
| Anhydrous ethyl alcohol | 1.0-2.0 |
| BENTONE ™ 38 organoclay stabilizer | 0.3-0.7 |
| Anhydrous isopropyl alcohol | 0.2-0.4 |
| Perfluoroalkoxy-perfluoroethylene copolymer | 0.25-1.5 |
| Perfluoroalkyl oligomer | 0.0-1.0 |
| Boric oxide particles | 0.01-0.10 |

In one embodiment of the invention, the polish is prepared as follows:
1. Combine the water and the KAOPOLITE™ in a high shear mixer.
2. Add the WITCAMIDE™ 511 emulsifier and the mineral spirits to the mixture in the high shear mixer and mix until uniform.
3. In a separate container dissolve the reactive aminofunctional silicone fluids in the anhydrous ethyl alcohol, then dissolve the reactive silicone resin into this solution.
4. Add the ethyl alcohol solution of the reactive silicone components to the aqueous dispersion above.
5. Once the aqueous dispersion has become a uniform paste, add the organoclay stabilizer, the anhydrous isopropyl alcohol, the perfluoroalkoxy-perfluoroethylene copolymer, the perfluoroalkyl oligomer and the boric oxide particles. Continue mixing until a uniform paste is again obtained.

In one embodiment of the invention, the surface to be protected is prepared as follows:
1. The surface is washed with an aqueous solution of detergent. This removes surface dirt and oils and allows maximum wetting and bonding of the polish to the surface.
2. If desired, the surface may then be etched slightly using an oxalic acid solution. This removes surface oxidation from the finish and further improves adhesion of the polish to the surface.

The polish typically is then applied to the cleaned surface using a sponge or cloth applicator and wiped over the surface until a uniform film is obtained. The polish is then wiped off the surface using a clean soft towel and a second coat of polish is wiped onto the surface. The second polish coat is then buffed with a clean terrycloth towel or buffing pad to achieve a durable high-gloss finish.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

What is claimed is:

1. A polish for applying a protective surface finish comprising a reactive silicone fluid, a silicone resin, an aluminum silicate, and a perfluoroalkoxy-perfluorethylene copolymer resin.

2. The polish of claim 1, further comprising barium oxide ceramic particles, such that the protective surface finish achieves an enhanced hardness and impact resistance.

3. The polish of claim 1, further comprising a perfluoroalkyl oligomer, such that the protective surface finish achieves an enhanced gloss and oil resistance.
